(19) United States
(12) Patent Application Publication
(10) Pub. No.: US 2011/0305189 A1
(43) Pub. Date: Dec. 15, 2011

(54) EXPLOITING BUFFERS IN COGNITIVE MULTI-RELAY SYSTEMS FOR DELAY-SENSITIVE APPLICATIONS

(75) Inventors: Yan Chen, Shanghai (CN); Vincent Kin Nang Lau, Hong Kong (CN); Shunqing Zhang, Shanghai (CN); Peiliang Qiu, Hangzhou (CN)

(73) Assignee: THE HONG KONG UNIVERSITY OF SCIENCE AND TECHNOLOGY, Hong Kong (CN)

(21) Appl. No.: 13/115,650

(22) Filed: May 25, 2011

Related U.S. Application Data
(60) Provisional application No. 61/352,942, filed on Jun. 9, 2010.

(51) Int. Cl. H04W 40/00; H04B 7/17; H04B 7/14

(52) U.S. Cl. 370/315; 455/7; 375/211

(57) ABSTRACT

Systems, methods, and computer-readable media for exploiting buffers in cognitive multi-relay systems for communicating delay sensitive application are presented herein. A secondary receiver device can select a first proximate relay station based on an assessment of communication links that extend from the first proximate relay station to the secondary receiver, and a secondary transmitter device that selects a second proximate relay station based on an evaluation of communication links that extend from the secondary transmitter and the second proximate relay station, wherein the first proximate relay station is employed by the secondary receiver device to communicate with the secondary transmitter device and the second proximate relay station is utilized by the secondary transmitter to communicate with the secondary receiver.

### PRIORITY CLAIM

This application claims priority to U.S. Provisional Patent Application Ser. No. 61/352,942, filed on Jun. 9, 2010, entitled “EXPLOITING BUFFERS IN COGNITIVE MULTI-RELAY SYSTEMS FOR DELAY-SENSITIVE APPLICATIONS”. The entirety of the aforementioned application is incorporated by reference herein.

### TECHNICAL FIELD

This disclosure relates generally to wireless networks including, but not limited to, cognitive and cooperative transmission in wireless networks.

### BACKGROUND

Cognitive and cooperative technologies are two core components in the design of next-generation wireless networks. A core idea behind cognitive transmission is to allow secondary users (SUs) to exploit under-utilized spectrum holes left by primary communication systems in the temporal, frequency, or spectral domains, without interfering with the regular transmissions of primary users (PUs).

One issue of cognitive radio (CR) systems is inefficient spectrum sharing with primary systems. For instance, direct transmission between secondary users separated by large distances typically demands greater power consumption with a commensurate reduction in access and low spectrum sharing efficiency. An attractive solution to boost spectrum sharing efficiency is cognitive radio combined with relay stations (RSs) such as cognitive multi-relay (CMR) systems.

Cognitive multi-relay systems are currently the subject of research that can be loosely categorized into the following investigative areas: delay-sensitive applications, exploiting spatial burstiness of primary users in cognitive multi-relay systems, and double-sided spatial diversity advantage in buffered cognitive multi-relay systems. The majority of investigations into delay-sensitive applications have been focused on the physical layer aspects of the issue, such as selection policy for multi-hop cognitive mesh networks and the outage performance of cognitive relay systems. These investigations have assumed delay insensitive applications and have focused on the physical (PHY) layer performance metrics such as average throughput or ergodic capacity. However, from the application point of view, real-time services with guaranteed quality of service (QoS) would be more appreciated, which motivates the joint consideration of physical layer and higher layer performance. In particular, when delay-sensitive applications are considered, other performance measures such as the stability region and the average end-to-end packet delay becomes critical, which can involve queuing theory (delay dynamics) and information theory (PHY dynamics). A brute force approach fails to provide viable solutions due to the complicated interactions of queries in cognitive multi-relay systems.

In the context of exploiting spatial burstiness of primary users in cognitive multi-relay systems, analysis has been carried out in the areas of cognitive multi-access network delays, delay-minimal opportunistic scheduling in cognitive radio networks, and the queue dynamics at the primary transmitter and the secondary transmitter as well as their interaction have been modeled. Nonetheless, these investigations have focused on the scenario where primary user coverage is much larger than the secondary system. In this scenario, whenever a primary user is active on a particular channel, all the secondary users have to remain silent or hop to other idle frequencies, in which case the spatial burstiness of the primary user cannot be exploited.

In connection with double-sided spatial diversity advantage in buffered cognitive multi-relay systems, investigations have revealed that, with relay selection, the same diversity order as the distributed space-time coding can be achieved with much reduced complexity. In conventional cognitive multi-relay systems with N relay stations, no buffering at the relay station nodes is considered. As a result, the standard decode-and-forward (DF) protocol as well as the relay selection schemes can only achieve an N-th order spatial diversity at one side (source-relay link or relay-destination link).

The above-described deficiencies are merely intended to provide an overview of some of the problems of conventional systems and techniques, and are not intended to be exhaustive. Other problems with conventional systems and techniques, and corresponding benefits of the various non-limiting embodiments described herein may become further apparent upon review of the following description.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject disclosure. Its sole purpose is to present some concepts of the disclosed subject matter in a simplified form as a prelude to the more detailed description presented later.

In accordance with various embodiments, the subject application pertains to scenarios where cognitive multi-relay coverage is much larger than primary user coverage (e.g., Part 74 devices), and as such it can be critical to exploit the spatial burstiness of primary user activities for efficient spectrum sharing in cognitive multi-relay systems. For instance, when a primary user is affecting the source to relay station link, the relay station to destination link can nonetheless still be valid, which is analogous to a transmission hole in the spatial domain. Further, by exploiting the queues in a cognitive multi-relay system, relay station selection diversity to simultaneously enhance the reliability of both the secondary transmitter to relay station links as well as relay station to secondary receiver links can be achieved.

In accordance with the foregoing therefor, the subject application describes a cognitive multi-relay buffered decode-and-forward (CMF-BDF) system, method, and protocol. The cognitive multi-relay buffered decode-and-forward system disclosed herein can dynamically adjust cognitive transmissions to exploit spatial primary user burstiness while simultaneously benefiting from the advantages of double-sided selection diversity. Substantial gains can hence be obtained in stability/delay performance over traditional decode-and-forward and direct transmission schemes, as well as the cognitive multi-relay decode-and-forward schemes without buffering capability at the relay stations.

In accordance with one or more various embodiments, the subject application describes a method that comprises selecting a first proximate relay station based at least in part on an assessment of communication links or a set of communication links that extend from the first proximate relay station to a secondary receiver, and selecting a second proximate relay station based at least in part on an evaluation of communication links that extend from a secondary transmitter and the second proximate relay station, wherein the first proximate relay station is employed by the secondary receiver to communicate with the secondary transmitter and the second proximate relay station is utilized by the secondary transmitter to communicate with the secondary receiver.

Additionally, in accordance with one or more further embodiments, the subject application discloses a system, comprising: a secondary receiver that selects a first proximate relay station based at least in part on an assessment of communication links that extend from the first proximate relay station to the secondary receiver, and a secondary transmitter that selects a second proximate relay station based at least in part on an evaluation of communication links that extend from the secondary transmitter and the second proximate relay station, wherein the first proximate relay station is employed by the secondary receiver to communicate with the secondary transmitter and the second proximate relay station is utilized by the secondary transmitter to communicate with the secondary receiver.

In accordance with yet further embodiments, the subject application describes a computer-readable medium storing computer executable instructions for causing a computer to execute instructions, the computer executable instructions, comprising: code for selecting a first proximate relay station based at least in part on an assessment of communication links that extend from the first proximate relay station to a secondary receiver, and code for selecting a second proximate relay station based at least in part on an evaluation of communication links that extend from a secondary transmitter and the second proximate relay station, wherein the first proximate relay station is employed by the secondary receiver to communicate with the secondary transmitter and the second proximate relay station is utilized by the secondary transmitter to communicate with the secondary receiver.

In accordance with still yet further embodiments, the subject application discloses a method, comprising: identifying a best relay station from a set of non-empty relay stations based on links between the set of non-empty relay stations and a secondary receiver or links between a secondary transmitter and the set of non-empty relay stations, and broadcasting an index of selected relay stations on a control channel when the best relay station is selected from the set of non-empty relay stations that are based on links between the set of non-empty relay stations and the secondary receiver.

Moreover, in further embodiments, the subject application describes a system, comprising: a component that identifies a best relay station from a set of non-empty relay stations based on links between the set of non-empty relay stations and a secondary receiver or links between a secondary transmitter and the set of non-empty relay stations, wherein the component broadcasts an index of selected relay stations on a control channel in response to the best relay station being selected from the set of non-empty relay stations that are based on links between the set of non-empty relay stations and the secondary receiver.

In yet further embodiments, the subject application describes a computer-readable medium storing computer executable instructions for causing a computer to execute instructions, the computer executable instructions, comprising: code for identifying a best relay station from a set of non-empty relay stations based on links between the set of non-empty relay stations and a secondary receiver or links between a secondary transmitter and the set of non-empty relay stations; and code for broadcasting an index of selected relay stations on a control channel when the best relay station is selected from the set of non-empty relay stations that are based on links between the set of non-empty relay stations and the secondary receiver.

Additionally, in still yet further embodiments, the subject application describes a method, comprising: receiving an acknowledgement packet from a secondary receiver; and deleting a packet from a buffer of infinite length in a first-in-first out manner, wherein the buffer is associated with a relay station selected by the secondary receiver based at least in part on non-primary user blocked links between the relay station and the secondary receiver and the non-primary user blocked links exhibiting a channel gain that exceeds the channel gain associated with other non-primary user blocked links between another relay station and the secondary receiver.

In yet further embodiments, the subject application discloses a system, comprising: an acknowledgment assessor that ascertains whether an acknowledgement has been received from a secondary receiver that selected the system based at least in part on non-primary blocked links between the system and the secondary receiver and the non-primary blocked links having channel gains that exceed channels gains exhibited by other non-primary user blocked links between other relay stations and the secondary receiver; and a packet deletion component that removes a packet off a buffer in a first-in-first-out manner in response to the acknowledgement assessor ascertaining that an acknowledgment has been received from the secondary receiver.

The subject application also discloses a computer-readable medium storing computer executable instructions for causing a computer to execute instructions, the computer executable instructions, comprising: code for receiving an acknowledgement packet from a secondary receiver, and code for deleting a packet from a buffer of infinite length in a first-in-first out manner, wherein the buffer is associated with a relay station selected by the secondary receiver based at least in part on non-primary user blocked links between the relay station and the secondary receiver and the non-primary user blocked links exhibiting a channel gain that exceeds the channel gain associated with other non-primary user blocked links between another relay station and the secondary receiver.

In still yet further embodiments, the subject application also describes a method, comprising: obtaining an acknowledgement packet sent from a selected relay station to a secondary transmitter, wherein the selected relay station was identified as being a preferable relay station based on non-primary user blocked communication links between the secondary transmitter and the selected relay station, the non-primary user blocked communication links have channel gains that exceed channels gains associated with other non-primary user blocked communication links from the secondary transmitter and other non-selected relays stations, and the selected relay station is not a selected relay station associated with a secondary receiver with which the secondary transmitter is in communication, and removing a packet from a queue associated with the secondary transmitter in response to obtaining the acknowledgement packet.

Additionally, the subject application also describes a system, comprising: an acknowledgment determinator that differentiates between an acknowledgement packet and a negative acknowledgement packet sent from a selected relay station to a secondary transmitter, wherein the selected relay station was identified as being a preferable relay station based on non-primary user blocked communication links between the secondary transmitter and the selected relay station, the non-primary user blocked communication links have channel gains that exceed channels gains associated with other non-primary user blocked communication links from the secondary transmitter and other non-selected relays stations, and the selected relay station is not a selected relay station associated with a secondary receiver with which the secondary transmitter is in communication, and packet removal component that removes a packet from a queue associated with the secondary transmitter based on receipt of the acknowledgement packet.

Furthermore, the subject application also describes a computer-readable medium storing computer executable instructions for causing a computer to execute instructions, the computer executable instructions, comprising: code for obtaining an acknowledgement packet sent from a selected relay station to a secondary transmitter, wherein the selected relay station was identified as being a preferable relay station based on non-primary user blocked communication links between the secondary transmitter and the selected relay station, the non-primary user blocked communication links have channel gains that exceed channels gains associated with other non-primary user blocked communication links from the secondary transmitter and other non-selected relays stations, and the selected relay station is not a selected relay station associated with a secondary receiver with which the secondary transmitter is in communication, and code for removing a packet from a queue associated with the secondary transmitter in response to obtaining the acknowledgement packet.

The following description and the annexed drawings set forth in detail certain illustrative aspects of the disclosed subject matter. These aspects are indicative, however, of but a few of the various ways in which the principles of the subject application can be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a block diagram of a large coverage cognitive multi-relay (CMR) system that can opportunistically access the licensed spectrum of randomly dispersed and distributed small-coverage primary user systems.

FIG. 2 illustrates a block diagram of a secondary transceiver that can be included or associated with a secondary transmitter and/or secondary receiver, in accordance with an embodiment.

FIG. 3 illustrates a block diagram of a secondary relay station that can opportunistically exploit, to the benefit of secondary user devices, spectrum holes left by primary communication systems without unduly interfering with communications by primary user devices, in accordance with an embodiment.

FIG. 4 illustrates a block diagram of an illustrative cognition component, in accordance with an embodiment.

FIG. 5 illustrates a block diagram of an illustrative percipience component, in accordance with an embodiment.

FIG. 6 illustrates links established between secondary transmitters and relay stations, and relay stations and secondary receivers, in accordance with an embodiment.

FIG. 7 illustrates the general flow and interaction of communication packets respectively emanating from and to primary user devices and/or secondary user devices, in accordance with an embodiment.

FIGS. 8-12 illustrate various processes associated with exploiting underutilized spectrum holes left by primary communication systems in the temporal, frequency, or spatial domains without interfering with transmission and/or reception by primary user devices that occupy a wireless regional area network.

FIG. 13 illustrates a block diagram of a computing system operable to execute the disclosed systems and methods, in accordance with an embodiment.

### DETAILED DESCRIPTION

Various non-limiting embodiments of systems, methods, and apparatus presented herein opportunistically exploit, to the benefit of secondary user devices, spectrum holes left by primary communication systems without unduly interfering with communications by primary user devices.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to select appropriate relay stations for secondary transmitter and secondary receivers randomly situated within a cognitive radio network, wherein the secondary receiver and secondary transmitter can base their respective decisions as to which relay station is the most suitable relay station at least in part on links between the relay station and the secondary receiver and the secondary transmitter and the relay station.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

To animate the following disclosure, it is assumed solely for purposes of exposition that a basic cognitive multi-relay system includes a secondary transmitter, a secondary receiver, and K half-duplex relay stations. The links between the secondary transmitter and relay stations can be termed “T-R links”, and the links between the relay stations and the secondary receiver can be referred to as “R-R links”. In order to reduce the interference region caused by secondary user transmissions, it can be assumed that antenna arrays are equipped at both the secondary transmitter and relay stations for beamforming with beamwidth θ rad and transmitter antenna gain Gₜ. When receiving signals at both relay stations and secondary transmitters, omnidirectional antennas are assumed. Further, it is assumed the transmission time of the cognitive multi-relay system is slotted. In any slot, if using power Pᵢⱼ to transmit signal X(with normalized signal energy) on link ij², the received signal at receiver j can be represented as:

Yⱼ=α(Pᵢⱼ)·hᵢⱼ\sqrt{PᵢⱼLᵢⱼGₜ}X+I_{Pj}+Zⱼ (1)

where α(Pᵢⱼ) is an indication variable and is a function of Pᵢⱼ. It indicates whether the transmission is from i to j using power Pᵢⱼ is blocked by any primary user, α(Pᵢⱼ)=0 indicates the transmission is blocked and α(Pᵢⱼ)=1 otherwise. hᵢⱼ stands for the channel fading coefficient, which is assumed to be flat Rayleigh so that the power gain on the link ij (e.g., Hᵢⱼ=|hᵢⱼ|²) is exponentially distributed with parameter 1. Hᵢⱼ is assumed to be quasi-static within a slot but identically and independently distributed between different slots. Lᵢⱼ=κ₀·Dᵢⱼ^{-ε} is the large-scale path-loss between i and j, where κ₀ and α are path-loss coefficient and exponent, respectively. I_{Pj} stands for the sum signals received from all neighboring active primary users at node i. Since the primary user's coverage is much smaller and it is assumed that the secondary receiver is not inside the coverage of any active primary user, then I_{Pj} can be treated as white noise with power [symbol] [I_{Pj}]=σ_{I}², ∀j·Zⱼ is white Gaussian noise at receiver j (e.g., Zⱼ˜N(0, σⱼ²) where it is assumed σⱼ²=σ², ∀j. Further, the instantaneous received signal-to-interference-and-noise ratio (SINR) on link ij can be defined as

$${γ}_{ij} = α ( {P}_{ij} ) \cdot {C}_{0} \cdot \frac{{P}_{ij}}{{D}_{ij}^{α}} \cdot {H}_{ij} ,$$

where

$${C}_{0} = \frac{{κ}_{0} {G}_{t}}{{σ}^{2} + {σ}_{I}^{2}}$$

is a constant irrelevant to the transmit power.

Further, it is also assumed that the primary users are uniformly and/or randomly distributed on a two-dimensional plane with density ρ. The activity of the i-th primary user can be presented by an ON-OFF state variable Sₜ=0, 1 where Sᵢ=1 denotes the ON state (e.g., the primary user is active) and conversely Sᵢ=0 denotes the OFF state (e.g., the primary user is idle). The activity states of the N primary users (S₁, . . . , S_{N}) can be assumed to be identically and independently distributed random variables. Furthermore, the primary user activity state remains static (e.g., [Pr(Sᵢ=1), Pr(Sᵢ=0)]=[π₁, π₀]) within a slot and identically and independently distributed between different slots.

By utilizing the indication variable α(Pᵢⱼ), the impact of primary user activities to received signal to interference to noise ratios on link ij can be related. When transmitting with power Pᵢⱼ, the average interference received by a primary user located a distance D_{SP} away can be denoted as

$${\overline{γ}}_{SP} ( {P}_{ij} , {D}_{SP} ) = {C}_{0} \cdot \frac{{P}_{ij}}{{D}_{SP}^{α}} .$$

When the interference level is higher than a threshold γₜₕ, interference to primary user transmissions would be a consequence. By setting γ̅_{SP}(Pᵢⱼ, D*_{SP})=γₜₕ the radius of the maximum interference region

$${D}_{SP}^{*} = {( \frac{{C}_{0}}{{γ}_{th}} \cdot {P}_{ij} )}^{1 / a} .$$

Since the directional beam with beamwidth θ rad can be approximated by a sector with angle

$$\frac{θ}{2 π} ,$$

the area of the interference region can be approximated by the area of the sector with angle

$$\frac{θ}{2 π}$$

and radius D*_{SP}, which can be represented as

$${A}_{SP} ( {P}_{ij} ) = ρ π {D}_{SP}^{* 2} \cdot \frac{θ}{2 π} .$$

According to the uniform distribution assumption, the number of primary users in the interference region can thus be calculated as:

$$N ( {P}_{ij} ) = ρ \cdot {A}_{SP} ( {P}_{ij} ) = ρ π {D}_{SP}^{* 2} \cdot \frac{θ}{2 π} .$$

The secondary user transmission on link ij is “blocked” if any of the N(Pᵢⱼ) primary users are active and α(Pᵢⱼ)=0. The probability that a secondary user transmission with power Pᵢⱼ is not blocked can be represented as:

$$\begin{matrix}\begin{matrix}Pr \{ a ( {P}_{ij} ) = 1 \} = Pr \{ {S}_{1} = 0 , {S}_{2} = 0 , … , {S}_{N ( {P}_{i} )} = 0 \} \\ = {\prod }_{k = 1}^{N ( {P}_{i} )} Pr \{ {S}_{k} = 0 \} = {π}_{0}^{N ( {P}_{ij} )}\end{matrix} & \begin{matrix}\begin{matrix}( 1 ) \\ \end{matrix} \\ \\ \end{matrix} \\ = exp \{ - {C}_{1} ( ρ , {π}_{0} ) \cdot {P}_{ij}^{2 / a} \} & ( 2 )\end{matrix}$$

where

$${C}_{1} ( ρ , {π}_{0} ) = \frac{ρ θ}{2} {( \frac{{C}_{0}}{{γ}_{th}} )}^{2 / a} ln \frac{1}{{π}_{0}} > 0$$

is a constant irrelevant with the transmit power Pᵢⱼ but directly related to primary user density ρ and activity density π₀. Step (1) is from the identically and independently distributed assumption for different primary users.

Additionally, it is further assumed that data from the secondary user system is encapsulated into small packets with R bits each. For each time slot, at most one packet can be transmitted which requires larger than R. using Shannon's formula, between node i and j can be expressed as Iᵢⱼ=log₂(1+γᵢⱼ), where γᵢⱼ is the signal to interference to noise ratio at receiver j. Thus, the probability of successful transmission of a packet over link ij, denoted as p_{succ,ij}, can be resolved as:

$$\begin{matrix}{p}_{succ , ij} ( {P}_{ij} ) = Pr \{ {log}_{2} ( 1 + {γ}_{ij} ) > R \} \\ = Pr \{ {H}_{ij} > \frac{( {2}^{R} - 1 ) {D}_{ij}^{a}}{{C}_{0} {P}_{ij}} \cdot \frac{1}{a ( {P}_{ij} )} \} \\ = Pr \{ {H}_{ij} > \frac{( {2}^{R} - 1 ) {D}_{ij}^{a}}{{C}_{0} {P}_{ij}} \} \cdot Pr \{ a ( {P}_{ij} ) = 1 \} \\ = exp \{ - {C}_{1} ( ρ , {π}_{0} ) \cdot {P}_{ij}^{2 / a} - \frac{{C}_{2} ( R , {D}_{ij} )}{{P}_{ij}} \} ,\end{matrix} \qquad \begin{matrix}( 1 ) \\ \\ \\ \\ \\ ( 3 )\end{matrix}$$

### Where

$${C}_{2} ( R , {D}_{ij} ) = \frac{( {2}^{R} - 1 )}{{C}_{0}} \cdot {D}_{ij}^{a} > 0$$

is a constant irrelevant to transmit power Pᵢⱼ but directly related to the packet size R and the distance between the two ends of the link Dᵢⱼ StepI (1) applies the result of equation (2).

Thus, for a given set of dᵢⱼ, R, ρ, and π₀, there exists a unique transmit power Pᵢⱼ^{opt}>0 that maximizes the probability of successful transmission over link ij

$$( e . g . , ∃ {P}_{i , j}^{*} , s . t . {P}_{ij}^{*} = arg {max}_{{P}_{ij}} {p}_{succ , ij} ( {P}_{ij} ) ) .$$

The optimal transmit power can thus be expressed as:

$${P}_{ij}^{*} = {( \frac{a}{2} \cdot \frac{{C}_{2} ( R , {D}_{ij} )}{{C}_{1} ( ρ , {π}_{0} )} )}^{\frac{a}{a + 2}} , \qquad ( 4 )$$

and the corresponding optimized probability of successful transmission over link ij is:

$${p}_{succ}^{*} ( {D}_{ij} ) = exp \{ - {C}_{3} \cdot {C}_{1}^{\frac{a}{a + 2}} ( ρ , {π}_{0} ) \cdot {C}_{2}^{\frac{2}{a + 2}} ( R , {D}_{ij} ) \} , \qquad ( 5 )$$

where

$${C}_{3} = ( 1 + \frac{a}{2} ) {( \frac{a}{2} )}^{- \frac{a}{a + 2}}$$

is a constant related to α.

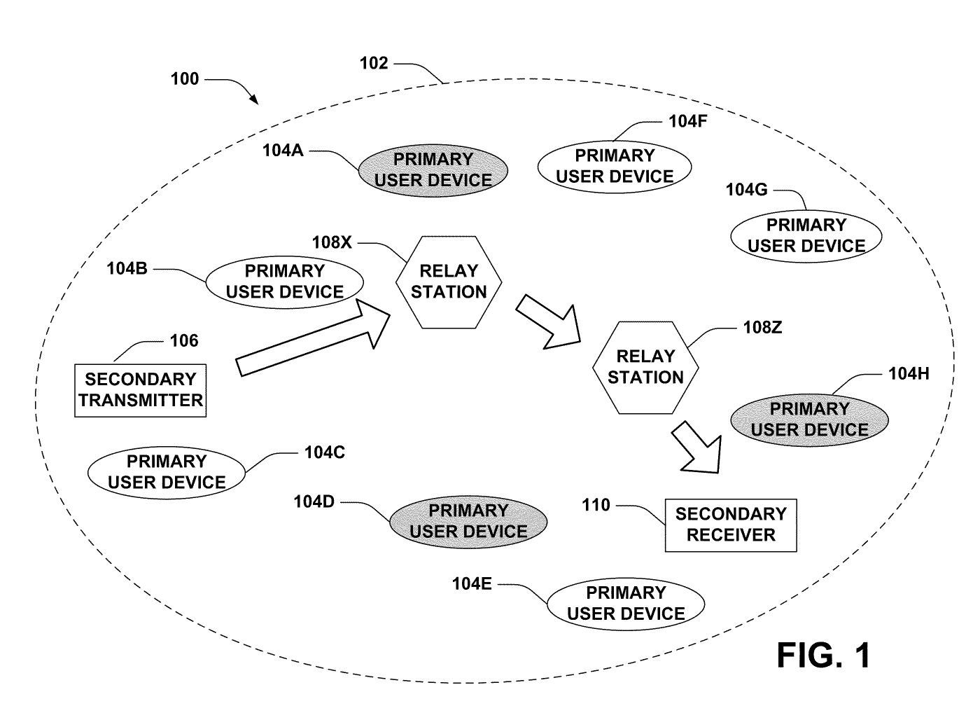

Turning now to the figures, FIG. 1 depicts a large coverage cognitive multi-relay (CMR) system 100 that can opportunistically access the licensed spectrum of randomly dispersed and distributed small-coverage primary user systems. The large coverage cognitive multi-relay system 100 can include a wireless regional area network (WRAN) system 102 that can provide wireless communications for a suburban college campus or town or a moderately sized rural area. Typically the coverage area or cell radius of the wireless regional area network system 102 can range from less than 2 kilometers to in excess of 10 kilometers. The wireless regional area network 102 can include a multitude of primary user devices (e.g., primary user devices 104A-104H) randomly situated throughout the coverage area and/or within the cell radius of the wireless regional area network system 102. Additionally, wireless regional area network 102 can also include secondary user transmitter 106 and secondary user receiver 110, as well as numerous relay stations 108X and 108Z. It should be noted that while FIG. 1 depicts one secondary transmitter 106 and one secondary receiver 110, multiple secondary transmitters and secondary receivers can be randomly dispersed throughout the coverage area provided by wireless regional area network system 102. Similarly, with regard to relay stations 108X and 108Z, while only two relays stations have been illustrated as being extant within the cell radius of wireless regional area network system 102, numerous relay stations (e.g., relay station 108X and relay station 108Z) can be positioned within wireless regional area network system 102.

Primary user devices 104A-104H can be associated with one or more wireless carrier or primary communication systems either in the temporal, frequency, or spatial domains. Generally the one or more wireless carrier or primary communication systems will own or have been allocated exclusive use of particular bands or sub-bands of wireless spectrum by a regulatory organization, for example. Thus, primary user devices 104A-104H will typically be tightly associated and/or exclusively utilize the resources (e.g., spectrum) provided by the one or more wireless carrier or primary communication systems. As will be recognized by those of ordinary skill, utilization of the allocated wireless spectrum exclusively by primary user devices 104A-104H can be extremely wasteful and inefficient since the full extent of the allocated wireless spectrum need not be fully employed for the majority of time. In fact, one survey conducted to find the extent to which the wireless spectrum is currently being utilized shows that some radio channels are employed less than one percent of the time, and the average occupancy over all frequency bands is only 5.2 percent. The survey also found that the maximum total spectrum occupancy for New York City in the 30-300 MHz sub-band, for example, during one measurement period was, surprisingly, only 13.1 percent, and that even during peak hours of usage, one could find free spaces in the spectrum of the public bands.

Primary user device 104A, primary user device 104D, and primary user device 104H are illustrated as being shaded, as these primary user devices, while being exclusively affiliated with a particular wireless carrier or specific primary communication system, can presently be inactive and thus are not employing the facilities provided by the wireless carrier or primary communication system. For example, primary user device 104A, primary user device 104D, and/or primary user device 104H can be associated with users that are temporarily inactive (e.g., devices that have been powered off and/or are not currently receiving/transmitting using the spectral resources offered by the primary communication system).

Secondary transmitter 106 and secondary receiver 110 can be devices that opportunistically exploit underutilized spectrum holes left by primary communication systems or the one or more wireless carriers, either in the temporal, frequency, or spatial domains, without interfering with the regular transmissions conducted by primary user devices 104A-104H. Secondary transmitter 106 and/or secondary receiver 110 therefore can employ any practical dynamic spectrum access scheme, such as spectrum spooling and/or opportunistic spectrum access (OSA).

Relay stations 108X and 108Z can be devices that receive signals and/or packets from one or more primary user devices 104A-104H and/or secondary transmitters (e.g., secondary transmitter 106) and rebroadcast the received signals and/or packets, either on the same frequency or on a different frequency, to receiving devices such as secondary receiver 110 or one or more primary user devices 104A-104H. Typically relay stations 108X and 108Z are interconnection devices that move or forward packets, frames, and/or signals between segments in a wired/wireless communication network, and normally can receive packets, frames, and/or signals in one form and thereafter retransmit the received packets, frames, and/or signals in a different form. Generally, relay station 108X and relay station 108Z receive packets, frames, and/or signals from a transmitter device, such as secondary transmitter 106, amplifies the received signal, shifts the signals in frequency, and rebroadcasts the frequency shifted signals. The rebroadcast frequency shifted signals can be received by another relay station where, if necessary, further amplification, frequency shifting, and rebroadcast of the signals can be carried out, or the frequency shifted signals can be received by a secondary receiver such as secondary receiver 110.

As will have been noted, relay station 108X and relay station 108Z have been depicted for purposes of ease of exposition as being associated and in communication with secondary transmitter 106 and secondary receiver 110. Relay station 108X and relay station 108Z can, with equal applicability, be in communication with primary transmission and reception devices (e.g., primary user devices 104A-104H). Thus, relay stations 108X and 108Z can contemporaneously be employed by both primary user devices 104A-104H and secondary user devices (e.g., secondary transmitter 106 and secondary receiver 110).

In connection with primary user devices (e.g., primary user devices 104A-104H) and secondary transmitter 106 and secondary receiver 110, typical examples of these devices include mobile devices, cell phones, personal digital assistants (PDAs), tablet computers/communication devices, consumer and/or commercial wired/wireless devices and electronic components, such as wired/wireless routers, wired/wireless hubs, wired/wireless access points, computers (e.g., desktop, laptop, net book, . . . ), and the like.

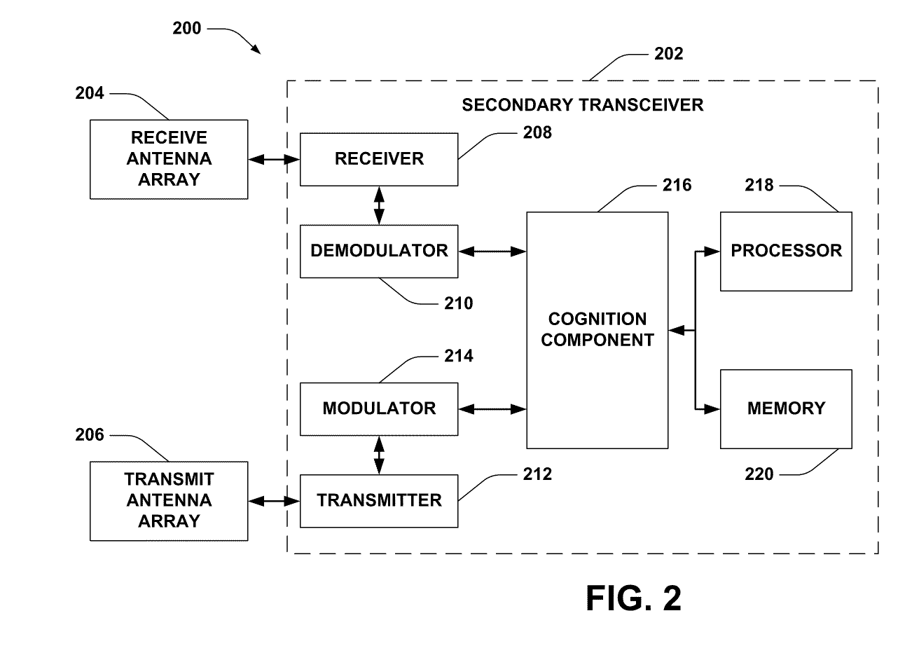

FIG. 2 illustrates a secondary transceiver 202 that can be included or associated with secondary transmitter 106 and/or secondary receiver 110. Secondary transceiver 202 can include a transmission side and a receiver side. The receiver side of secondary transceiver 202 can include receiver 208 that receives signals from one or more relay stations (e.g., relay station 108X and/or relay station 108Z) through a plurality of receive antennas provided by receive antenna array 204. Receiver 208 can receive information from receive antenna array 204 and is operatively associated with demodulator 210 that demodulates the received information. Demodulated symbols can be analyzed by a processor 218 that can be a processor dedicated to analyzing information received by receiver 208 and/or generating information for transmission by transmitter 212, a processor that controls one or more components of secondary transceiver 202, and/or a processor that both analyzes information received by receiver 208, generates information for transmission by transmitter 212, and controls one or more components of secondary transceiver 202, and which is coupled to a memory 220 that stores data to be transmitted to or received from relay station 108X or relay station 108Z (or disparate relay stations (not shown)), and/or any other suitable information related to performing the various actions and functions set forth herein. Processor 218 is further coupled to a cognition component 216 that, as will be described subsequently, exploits buffers in a cognitive multi-relay system (e.g., large coverage cognitive multi-relay system 100) to beneficially dispatch and/or receive delay-sensitive applications to and from secondary user devices (e.g., secondary transmitter 106 and secondary receiver 110).

The transmission side of secondary transceiver 202 can include transmitter 212 that transmits to the one or more relay stations (e.g., relay station 108X and/or relay station 108Z) through transmit antenna array 206. Typically, transmitter 212 is coupled to modulator 214 that can multiplex frames for transmission by transmitter 212 via transmit antenna array 206 to relay station 108X and/or relay station 108Z. Although depicted as being separate from processor 218, it is to be appreciated that cognition component 216 can be part of processor 218 or a number of processors (not shown).

Cognition component 216 can typically be sequentially employed by the receiver side and transmitter side of secondary transceiver 202 to ascertain, identify, or select the best relay station (e.g., relay station 108X or relay station 108Z) from amongst a plurality of relay stations that can be operational within a coverage area or cell radius of a wireless regional access network. Cognition component 216, from the perspective of the receiver side (e.g., as would be employed by secondary receiver 110), can initially select a relay station from amongst the plurality of operational relay stations within the ambit of the wireless regional area network coverage area (e.g., wireless regional area network 102 depicted in FIG. 1) that have non-primary user blocked links (e.g. operational relay stations that are not, at the time of the selection/identification, operationally occupied servicing primary user devices) and at the same time a relay station that provides the largest channel gain among all the non-primary user blocked links. In this instance, the links that cognition component 216 employs in ascertaining or identifying the best relay station from the perspective of the receiver side of secondary transceiver 202 are links from and to relay station 108Z and receiver 208, for example.

Once cognition component 216 has ascertained an appropriate relay station (or a set of appropriate relay stations) for utilization, cognition component 216, through facilities provided by modulator 214, transmitter 212, and transmit antenna array 206, can broadcast an index of selected relay stations on a control channel. The control channel, in this instance is typically a narrow band control channel capable of handling the exchange of acknowledgment and/or negative acknowledgment (ACK/NACK) packets and selection results.

From the perspective of the transmitter side of secondary transceiver 202 (e.g., as would be employed by secondary transmitter 106), cognition component 216 can pick, select, or identify the best available relay station from amongst all the functional relay stations within the cell radius provided by the wireless regional area network, except for the relay station that was identified or selected by cognition component 216 for purposes of the receiver side. The selection by cognition component 216 for an appropriate relay station for transmission can therefore be based on or be a function of the index of selected relay stations previously compiled by cognition component 216 for purposes of selecting a suitable relay station for reception, a relay station that has non-primary user blocked links to transmitter 212, and/or a relay station that has the largest channel gain among all the non-primary user blocked links to and from transmitter 212 and relay station 108Z, for instance. As will be noted in this regard, from the perspective of selecting an appropriate relay station for transmission, cognition component 216 typically will select the second best relay station for transmission purposes but the very best relay station for reception purposes, thus placing a premium on reception over transmission.

Once the foregoing double-sided selection has been completed, the reception side and the transmission side of the secondary transceiver 202 can utilize the established links between selected relay stations (e.g., links between secondary receiver 110 and relay station 108Z and links between relay station 108X and secondary transmitter 106) for the respective purposes of reception and transmission of packet data from and to secondary transmitter 106 and secondary receiver 110.

Moreover, after the double-sided selection and/or association of relay stations for the respective purposes of reception and transmission by secondary transceiver 202, cognition component 216 can further be utilized in connection with removing packets from a buffer or queue of infinite length associated with the transmitter side of secondary transceiver 202. Generally, the infinitely long buffer or queue associated with the transmission side of secondary transceiver 202 can operate in a first-in-first-out manner. Thus, cognition component 216, in conjunction with the associated infinitely long buffer and a component that ascertains whether or not acknowledgment or negative acknowledgment packets have been received from the selected relay station associated with the transmission side (e.g., relay station 108X), removes a packet from the buffer or queue in a first-in-first-out manner when an acknowledgment (ACK) packet is received from the selected relay station associated with the transmission side of secondary transceiver 202. Packets however are typically not removed from the infinitely long buffer or queue associated with the transmission side of secondary transceiver 202 when a negative acknowledgement (NACK) packet is received from the relay station affiliated with the transmission side of secondary transceiver 202.

Cognition component 216 can also be involved in ascertaining and/or determining an optimal transmit power to be employed by transmitter 212 to maximize the probability of successful transmission over the link that is established from transmitter 212 to the selected relay station. Accordingly, in one embodiment, cognition component 216 can employ the optimal transmit power equation:

$${P}_{ij}^{*} = {( \frac{a}{2} \cdot \frac{{C}_{2} ( R , {D}_{ij} )}{{C}_{1} ( ρ , {π}_{0} )} )}^{\frac{a}{a + 2}} ,$$

set forth above as equation (4), to maximize the probability of successful transmission over the link established between the transmitter side of secondary transceiver 202 and the selected relay station.

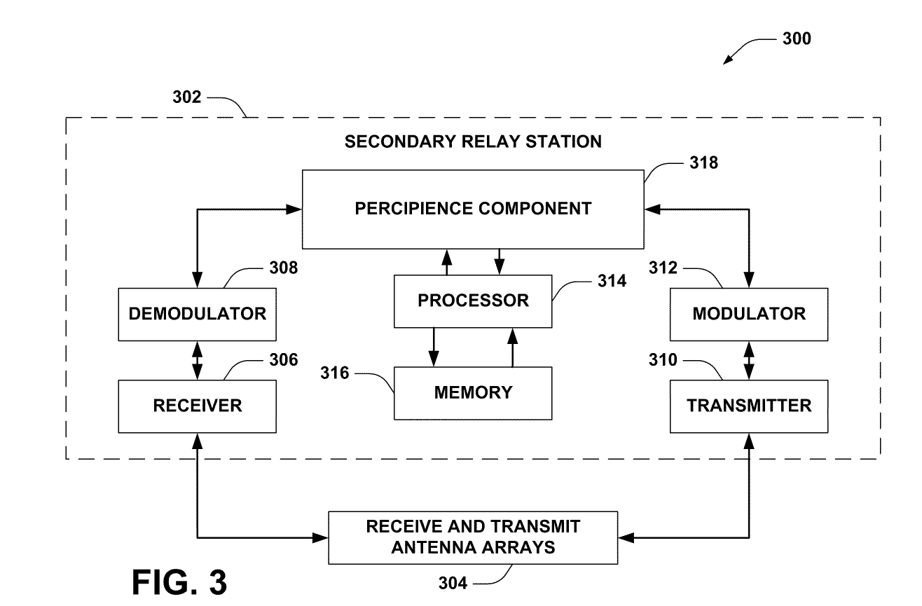

FIG. 3 depicts a system 300 that facilitates and/or effectuates the exploitation of buffers in cognitive multi-relay systems, such as the large coverage cognitive multi-relay system depicted in FIG. 1, to beneficially dispatch and/or receive delay-sensitive applications. System 300 comprises secondary relay station 302 with a receiver 306 that receives signals through receive and transmit antenna arrays 304 from one or more primary user devices (e.g., primary user devices 104A-104H), secondary transmitter 106, secondary receiver 110, and/or other relay stations operating within the coverage area or cell radius of the wireless regional area network system 102. Secondary relay station 302 also includes a transmitter 310 that transmits, through receive and transmit antenna arrays 304, to one or more primary user devices (e.g., primary user devices 104A-104H), secondary transmitter 106, secondary receiver 110, and/or other relay stations extant within the coverage area of the wireless regional area network system 102. Receiver 306 can receive information from receive and transmit antenna arrays 304 and is operatively associated with the demodulator 308 that demodulates received information. Demodulated symbols are analyzed by a processor 314 that can be a processor dedicated to analyzing information received by receiver 306 and/or generating information for transmission by a transmitter 310, a processor that controls one or more components of secondary relay station 302, and/or a processor that both analyzes information received by receiver 306, generates information for transmission by transmitter 310, and controls one or more components of relay station 302, and which is coupled to a memory 316 that stores data to be transmitted to or received from one or more primary user devices (e.g., primary user devices 104A-104H), secondary transmitter 106, secondary receiver 110, and/or other relay stations and/or any other suitable information related to performing the various actions and functions set forth herein. Processor 314 is further coupled to a percipience component 318 that, as will be describe infra, facilitates and/or effectuates exploitation of buffers in cognitive multi-relay systems to beneficially dispatch and/or receive delay-sensitive applications to or from secondary user devices within the coverage area or cell radius of a wireless regional area network. Modulator 312 can multiplex a frame for transmission by transmitter 310 through receive and transmit antenna arrays 304 to one or more primary user devices, secondary transmitter 106, secondary receiver 110, and/or other relay stations that can exist within the coverage area of the wireless regional area network system. Although depicted as being separate from processor 314, it is to be appreciated that percipience component 318 can be part of processor 314 or a number of processors (not shown).

Percipience component 318 can utilize, monitor, and control an infinitely long buffer or queue implemented on, and associated with, secondary relay station 302 for purposes of exploiting underutilized spectrum holes left by primary communication systems in the temporal, frequency, or spatial domains without interfering with the regular transmissions of primary user devices that presently occupy the wireless regional area network. Percipience component 318, like cognition component 216, can continuously and/or periodically monitor the infinitely long buffer or queue associated with secondary relay station 302, as well as a narrow-band control channel that can be employed to handle the exchange of acknowledgment packets and/or negative acknowledgment packets received from, or sent to, devices (e.g., both primary as well as secondary user devices) extant within the coverage area or cell radius provided by the wireless regional area network. According to one or more various embodiments, percipience component 318, on obtaining or identifying an acknowledgment packet (e.g., received on the narrow-band control channel) from a secondary receiver that has selected secondary relay station 302 for secondary user communication, while maintaining a first-in-first-out queuing or buffering management mechanism, can delete or remove a packet from the infinitely long queue or buffer associated with secondary relay station 302. Where percipience component 318 receives a negative acknowledgment packet from the secondary receiver that has selected or identified secondary relay station 302 for communication, based at least in part on the attributes of enunciated above in connection with a secondary receiver selecting an appropriate relay station (e.g., identifying the best relay station among all non-primary user blocked links, and thereafter broadcasting an index of selected relay stations on a control channel), percipience component 318 generally does not remove packets from the infinitely long buffer or queue affiliated with secondary relay station 302.

It should be noted that secondary relay station 302 as depicted in FIG. 3 can have correspondence with relay station 108X and/or relay station 108Z, or, for that matter, any other relay station within the cell radius of the wireless regional area network system. Further, with respect to the data store (e.g., memory 220 and memory 316) described in connection with FIGS. 2-3 above, the data store can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). These respective memories (e.g., memory 220 and memory 316) of the subject systems and methods is intended to comprise, without being limited to, these and any other suitable types of memory.

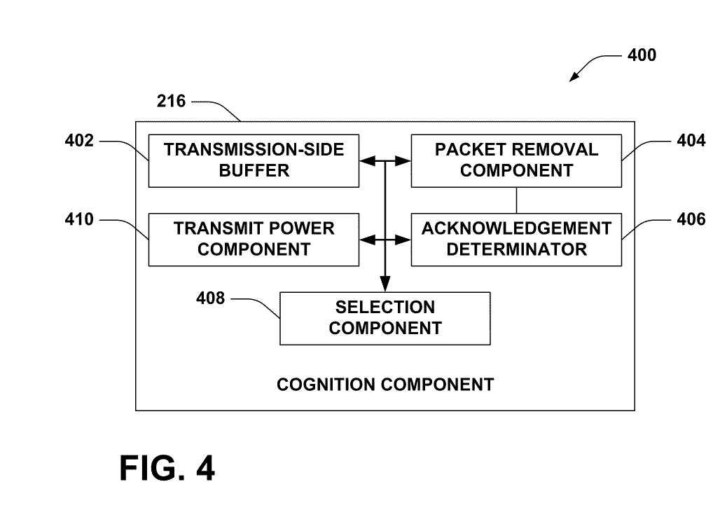

FIG. 4 provides a fuller illustration 400 of cognition component 216 that can include a transmission side buffer 402 that can be of an infinite length, a packet removal component 404 that can continuously and/or periodically remove packets queued or buffered in transmission side buffer 402 when acknowledgement determinator 406 ascertains that a packet received from a relay station selected and associated with the transmission side of secondary transceiver 202 is an acknowledgment (ACK) packet. As has been stated supra, removal component 404 removes packets from the transmission side buffer 402 in a first-in-first-out manner. Thus, packets that entered transmission side buffer 402 first will be removed from transmission side buffer 402 first.

As depicted cognition component 216 can also include selection component 408 that can be employed to effectuate selection of appropriate relay stations to associate with the reception and/or transmission sides of secondary transceiver 202. According to one or more various embodiments, selection component 408 can select a relay station to associate with on the receiver side of secondary transceiver 202 by investigating whether a prospective relay station has non-primary user blocked links, and whether the links between the putative relay station and the secondary transceiver (e.g., receiver 208) have the largest channel gains in relation to all the non-primary user blocked links from the relay station to the receiver associated with secondary transceiver 202. Where selection component 408 identifies a set of candidate relay stations with appropriate attributes, selection component 408 can broadcast an index of relay stations wherein the index of relay stations will generally include the identified set of relay stations on a control channel.

Selection component 408 can also perform a similar process for selection of an appropriate relay station to associate with the transmitter side of secondary transceiver 202. Here, selection component 408 can identify the best available relay station by, for example, employing the broadcast index of relay stations to identify or select a relay station that exhibits the following properties: a relay station that has non-primary user blocked links extending from the transmitter associated with secondary transceiver 202 to the relay station wherein the links exhibit the largest channel gain among all the non-primary user blocked links between the associated transmitter and the relay station; and a relay station that is not the relay station that was selected by the receiver side of secondary transceiver 202.

Further, cognition component 216 can also be associated with a transmit power component 410 that can optimize transmit power in order to maximize the probability of successful transmission over the link established from the transmitter associated with the secondary transceiver 202 and the relay station selected for the purposes of secondary user transmission. For example, transmit power component 410 can utilize

$${P}_{ij}^{*} = {( \frac{a}{2} \cdot \frac{{C}_{2} ( R , {D}_{ij} )}{{C}_{1} ( ρ , {π}_{0} )} )}^{\frac{a}{a + 2}} ,$$

set forth above as equation (4), to maximize the probability of successful transmission over the link established between the transmitter side of secondary transceiver 202 and the selected relay station.

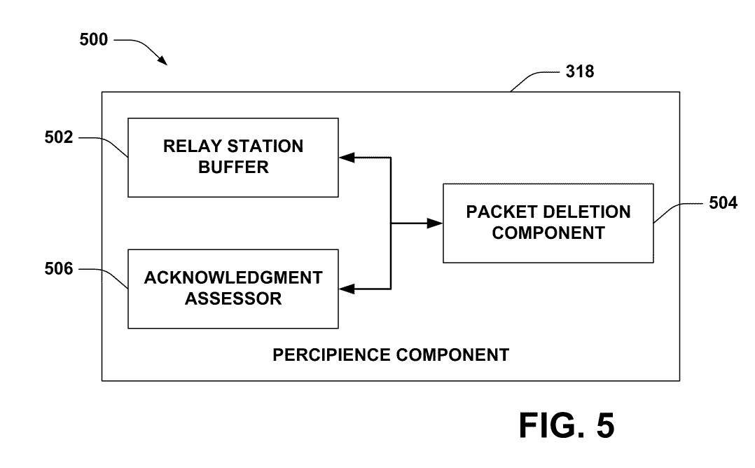

FIG. 5 provides a more comprehensive depiction 500 of percipience component 318 that can include a relay station buffer 502, that like the transmission side buffer 402 described above, can be of infinite length and can operate such that the order in which packets arrive determines the order in which the packets are removed from relay station buffer 502 by packet deletion component 504. Thus, packet deletion component 504 will typically remove from relay station buffer 502 the packet that arrived earliest. Packet deletion component 504 generally removes packets from relay station buffer 502 on identification by acknowledgment assessor 506 of an acknowledgment packet received from a secondary receiver that has selected the relay station in which the percipience component 318 has been included. Where acknowledgment assessor 506 identifies receipt of negative acknowledgement packets from a secondary receiver that has selected the relay station in which percipience component 318 has been included, packet deletion component 502 typically will not remove packets from relay station buffer 502.

It should be observed in relation to the functionality of the foregoing secondary transceiver 202 and secondary relay station 302 that transmission time is typically slotted and that packet transmission commences at the beginning of a time slot. In each slot, only one packet is transmitted using a transmit power that maximizes the probability of successful transmission over a link (e.g., a link from a secondary transmitter to a selected relay station and/or a link from a selected relay station to a secondary receiver).

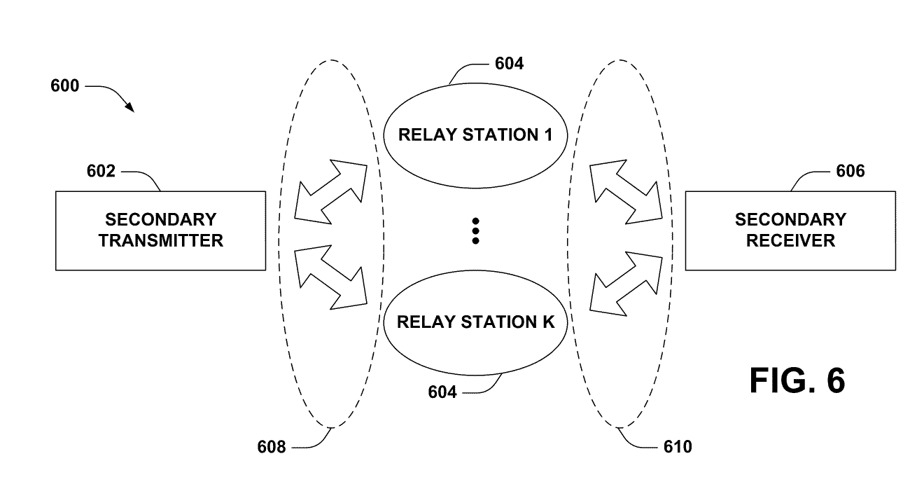

FIG. 6 provides illustration 600 of links established between secondary transmitters and relay stations and relay stations and secondary receivers. As depicted, secondary transmitter 602 can be in operative communication with relay station 1, . . . , relay station K (collectively referred to as relay stations 604), where K is an integer equal to or greater than 1. Secondary transmitter 602 can communicate with relay stations 604 over transmitter to relay station links 608 that can have been established between secondary transmitter 602 and relay stations 604 through the praxis outlined above in association with FIG. 2, for instance.

Further as also illustrated, relay stations 604 can also be in operative communication with secondary receiver 606 over links 610 established between relay stations 604 and secondary receiver 606. These relay stations 604 to secondary receiver 610 links can have been developed between relay station 604 and secondary receiver 606 in a manner previously enunciated in connection with FIG. 2, for example.

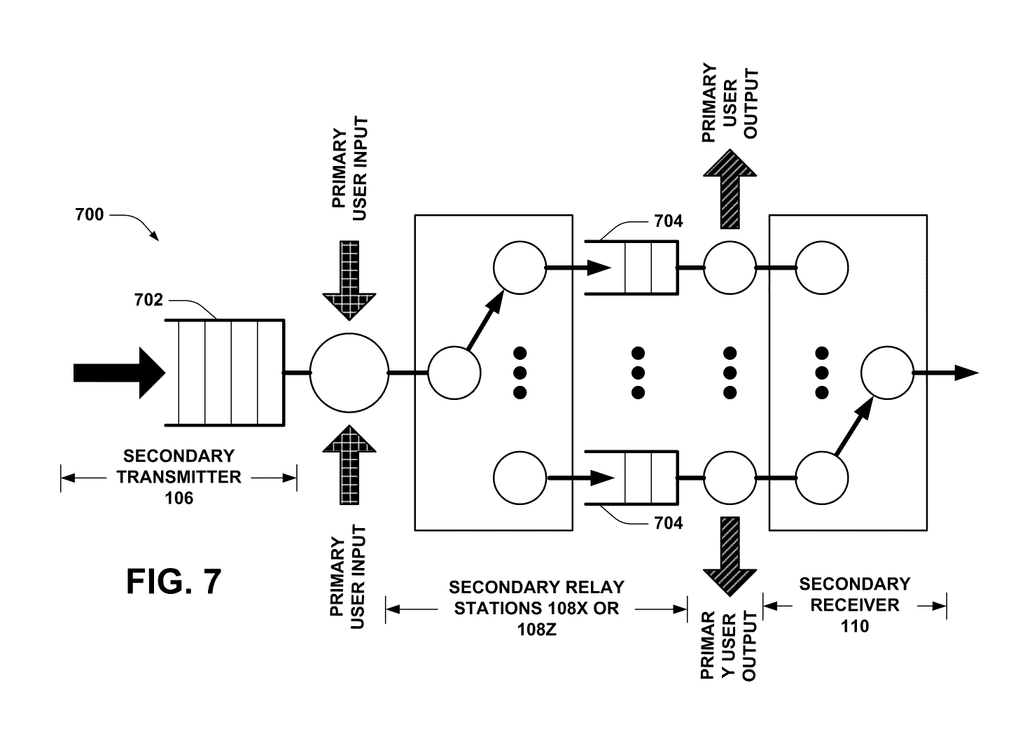

FIG. 7 provides depiction 700 of the general flow and interaction of communication packets respectively emanating from primary user devices and/or secondary user devices. An infinitely long buffer 702, that typically is associated with secondary transmitter 106, can be managed so that the earliest packets to enter the infinitely long buffer 702 typically are the first packets to be removed from infinitely long buffer 702. Thus, communication packets with the oldest timestamps are deleted/removed from the infinitely long buffer 702 prior to communications associated with packets of relatively less age extant in the infinitely long buffer 702. Infinitely long buffer 702, being associated with secondary transmitter 106, can queue the packets generated by secondary transmitter 106 while primary user traffic is traveling through the wireless regional area network. Thus, as will be recognized, when primary user traffic is traversing through the wireless regional area network, transmissions associated with secondary user devices can be placed in abeyance to ensure that primary user transmissions are not impinged upon in any way, hence the necessity for the infinitely long buffer 702 associated with secondary transmitter 106.

Also illustrated in FIG. 7 are the infinitely long buffers respectively associated with or included in each of the selected relay stations (e.g., relay stations 108X and/or 108Z), collectively identified as relay station buffers 704. Once again, as stated above in connection with the infinitely long buffer 702 associated with secondary transmitter 106, because in a cognitive radio system operational in a wireless regional area network, transmission and reception connected with primary user traffic will typically take precedence over the transmission and reception of traffic associated with secondary user devices, transmission of traffic associated with secondary user devices can be queued in the relay station buffers 704 while traffic associated with primary user devices is preferentially handled in priority over traffic associated with secondary user devices.

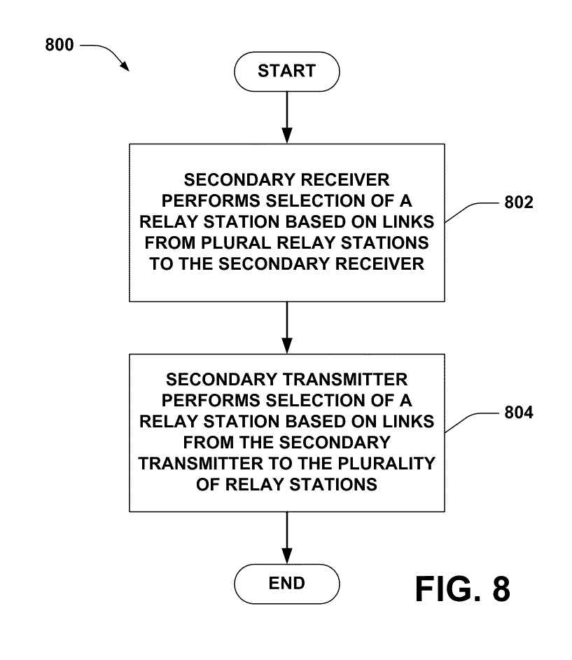

FIGS. 8-12 illustrate methodologies in accordance with the disclosed subject matter. For simplicity of explanation, the methodologies are depicted and described as a series of acts. It is to be understood and appreciated that the subject application is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 8 provides a flowchart that outlines a process or method 804 for exploiting buffers in cognitive multi-relay systems in order to facilitate communication over delay sensitive applications between secondary transmitters and secondary receivers randomly dispersed throughout a wireless regional area network system as depicted, for instance, in FIG. 1. Method 800 commences at 802 where a secondary receiver identifies or selects an appropriate relay station, or a set of suitable relay stations, from a plurality or a set of extant and/or functional relay stations randomly situated throughout the coverage area and within the cell radius circumscribed or serviced by the wireless regional area network system. Generally at 802, the secondary receiver effectuating the selection of an appropriate relay station or sets of suitable relay stations identifies and/or selects the best relay station amongst all non-empty relay stations based at least in part on the communication links, or a set(s) of communication links, extending from the relay station to the secondary receiver. A best relay station is typically one that has non-primary user blocked links between the relay station and the secondary receiver as well as has the largest channel gain amongst all the non-empty relay station links extending between the relay station and secondary receiver. It should be noted in the context of a set(s) of communication links, that a set can comprise a communication link or one or more communication links. Once the secondary receiver has identified and/or selected an appropriate relay station, or a set of suitable relay stations with which to conduct communications with other disparate secondary devices, secondary receiver can broadcast an index of selected relay stations on a control channel, wherein the control channel is a narrow-band channel that handles the exchange of acknowledgment and/or negative acknowledgement packets and selection results.

At 804, a secondary transmitter, such as secondary transmitter 106, can perform identification and/or selection of an appropriate relay station for purposes of transmission to other secondary devices randomly scattered in the circumscribed coverage area provided by the wireless regional area network system. Thus, the secondary transmitter can pick the best relay station from all available relay stations except for the relay station that was identified and/or selected by the secondary receiver with which the secondary transmitter is to be in counterpart communication. The identification and/or selection of an appropriate relay station to carry out communication with other secondary devices can be based at least in part on non-primary user blocked links to and/or from the secondary transmitter and the relay station, as well as the non-primary user blocked links that exhibit the largest channel gain amongst all the non-primary user blocked links from the secondary transmitter to the relay station.

Once method 800 has completed, the secondary transmitter and the secondary receiver can transmit simultaneously utilizing their respectively selected relay stations.

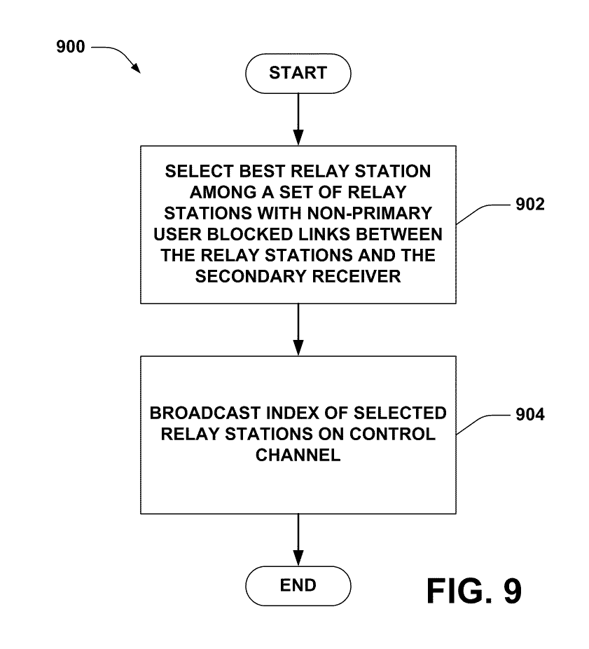

FIG. 9 outlines in flowchart form a method or process 900 that can be employed by a secondary receiver to identify or select a relay station through which communication can be conducted with a remote secondary transmitter. Method or process 900 can commence at 902 wherein the best relay station amongst all non-primary user blocked relay stations can be identified and selected, the identification/selection can be based at least in part, for example, on a relay station having non-primary user blocked links between the relay station and a secondary receiver and/or a non-primary user blocked links extending between the relay station and secondary receiver that provide the largest channel gain with respect to all the other as a non-primary user blocked links. Once secondary receiver has selected a relay station, or sets of relay stations, to be employed in communicating with a secondary transmitter, at 904 the secondary receiver can compile and broadcast an index that can include the identified/selected relay station, or the sets of relay stations, the secondary receiver proposes to utilize to communicate with secondary transmitter.

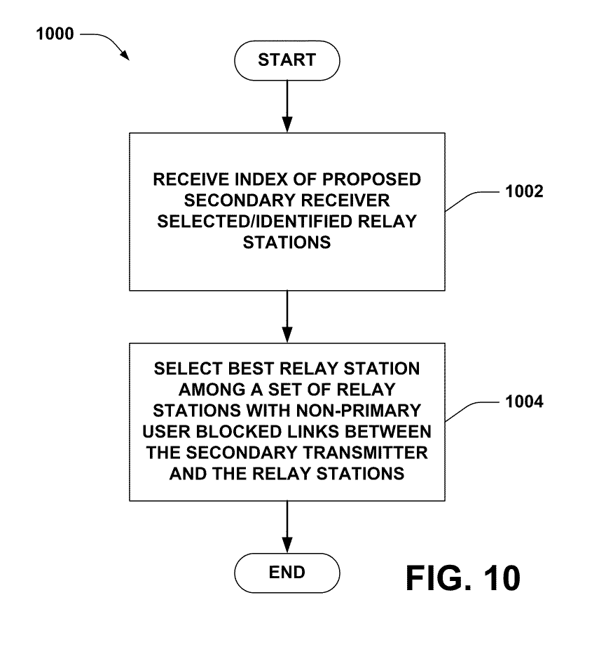

FIG. 10 illustrates a further flow diagram illustrating a method 1000 that can be employed on a secondary transmitter to effectuate selection of a relay station situated within the circumscribed coverage area serviced by a cognitive multi-relay system. Method 1000 can commence at 1002 wherein a secondary transmitter can receive from a secondary receiver an index of selected/identified relay stations that the secondary receiver proposes to communicate with secondary transmitter over. At 1004, the secondary transmitter can utilize the index of selected or identified relay stations together with its own assessment of the non-primary user blocked links that extend between the secondary transmitter and one or more relay stations, wherein the appraisal regarding the non-primary user blocked links from the secondary transmitter to the relay stations includes an evaluation of the secondary transmitter to relay stations links that will provide the largest channel gain advantage of amongst all the primary user blocked links.

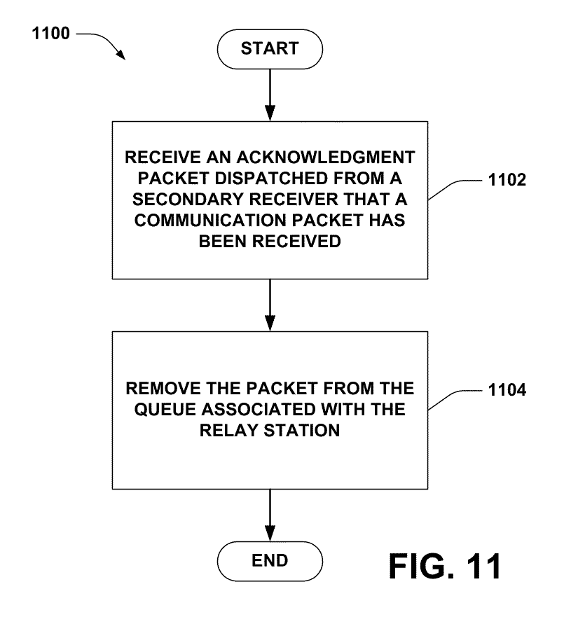

FIG. 11 depicts a method 1100 that generally can be used by a relay station that facilitates secondary user communications within a cognitive radio network. Method 1100 can commence at 1102 where a selected relay station can receive an acknowledgment packet from a secondary receiver that has selected the relay station as being its best relay station for purposes of receiving packets from a secondary transmitter. On receiving the acknowledgement packet, the relay station at 1104 can remove a packet from an infinitely long buffer or queue that is associated with the relay station in a first-in-first-out manner.

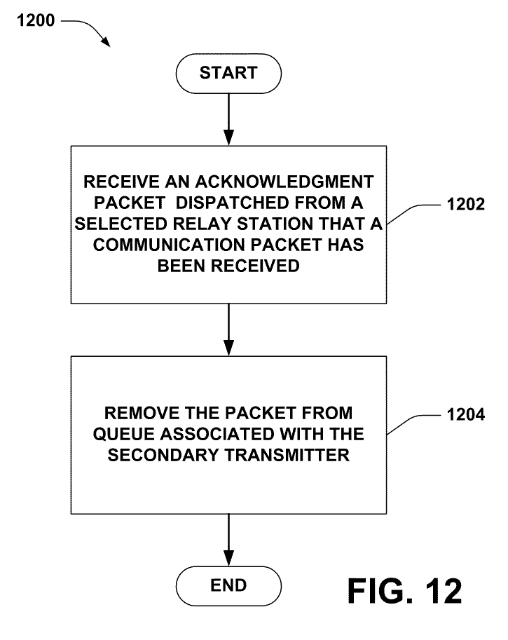

FIG. 12 illustrates a process or method 1200 that typically can be implemented on a secondary transmitter and that facilitates secondary user communication within a cognitive radio network. The method or process 1200 commences at 1202 where an acknowledgment packet dispatched from a relay station identified and selected by the secondary transmitter for purposes of communication with a secondary receiver is received. The acknowledgment packet typically indicates that communicated data packets have been received without any detected transmission errors. On receipt of the acknowledgment packet from the relay station associated with the secondary transmitter, the secondary transmitter at 1204 can delete or remove a packet from an infinitely long queue or buffer associated with the secondary transmitter.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in storage systems described above, non-volatile memory 1222 (see below), disk storage 1324 (see below), and memory storage 1346 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

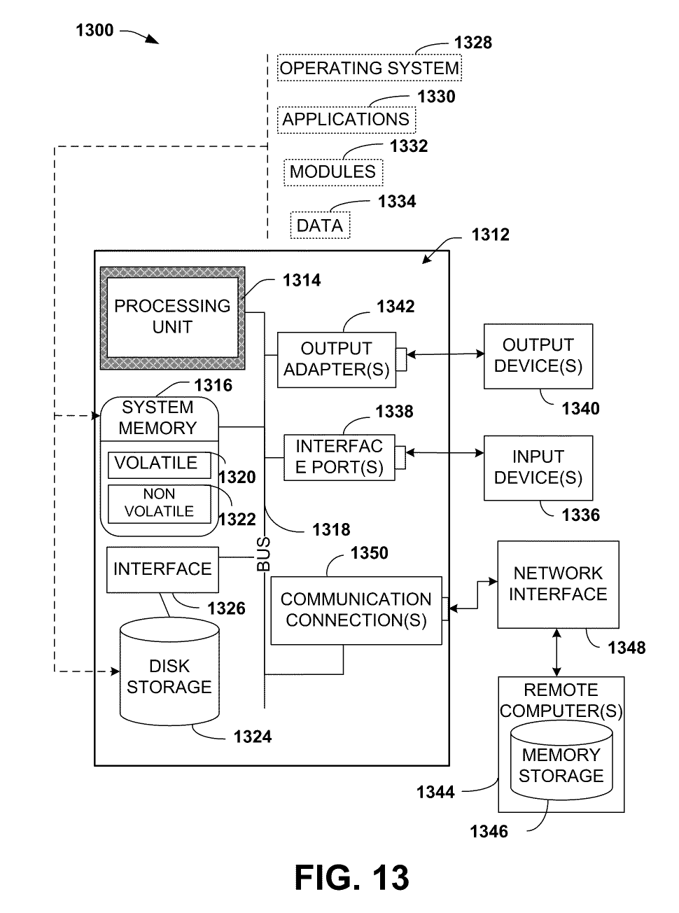

In order to provide a context for the various aspects of the disclosed subject matter, FIG. 13, and the following discussion, are intended to provide a brief, general description of a suitable environment in which the various aspects of the disclosed subject matter can be implemented, e.g., various processes associated with FIGS. 1-12. While the subject matter has been described above in the general context of computer-executable instructions of a computer program that runs on a computer and/or computers, those skilled in the art will recognize that the subject application also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 13, a block diagram of a computing system 1300 operable to execute the disclosed systems and methods is illustrated, in accordance with an embodiment. Computer 1312 includes a processing unit 1314, a system memory 1316, and a system bus 1318. System bus 1318 couples system components including, but not limited to, system memory 1316 to processing unit 1314. Processing unit 1314 can be any of various available processors. Dual microprocessors and other multiprocessor architectures also can be employed as processing unit 1314.

System bus 1318 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1316 includes volatile memory 1320 and nonvolatile memory 1322. A basic input/output system (BIOS), containing routines to transfer information between elements within computer 1312, such as during start-up, can be stored in nonvolatile memory 1322. By way of illustration, and not limitation, nonvolatile memory 1322 can include ROM, PROM, EPROM, EEPROM, or flash memory. Volatile memory 1320 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 can also include removable/non-removable, volatile/non-volatile computer storage media, networked attached storage (NAS), e.g., SAN storage, etc. FIG. 13 illustrates, for example, disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to system bus 1318, a removable or non-removable interface is typically used, such as interface 1326.

It is to be appreciated that FIG. 13 describes software that acts as an intermediary between users and computer resources described in suitable operating environment 1300. Such software includes an operating system 1328. Operating system 1328, which can be stored on disk storage 1324, acts to control and allocate resources of computer 1312. System applications 1330 take advantage of the management of resources by operating system 1328 through program modules 1332 and program data 1334 stored either in system memory 1316 or on disk storage 1324. It is to be appreciated that the disclosed subject matter can be implemented with various operating systems or combinations of operating systems.

A user can enter commands or information into computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1314 through system bus 1318 via interface port(s) 1338. Interface port(s) 1338 include, for example, a serial port, a parallel port, a game port, and a universal serial bus (USB). Output device(s) 1340 use some of the same type of ports as input device(s) 1336.

Thus, for example, a USB port can be used to provide input to computer 1312 and to output information from computer 1312 to an output device 1340. Output adapter 1342 is provided to illustrate that there are some output devices 1340 like monitors, speakers, and printers, among other output devices 1340, which use special adapters. Output adapters 1342 include, by way of illustration and not limitation, video and sound cards that provide means of connection between output device 1340 and system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. Remote computer(s) 1344 can be a personal computer, a server, a router, a network PC, a workstation, a microprocessor based appliance, a peer device, or other common network node and the like, and typically includes many or all of the elements described relative to computer 1312.

For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refer(s) to hardware/software employed to connect network interface 1348 to bus 1318. While communication connection 1350 is shown for illustrative clarity inside computer 1312, it can also be external to computer 1312. The hardware/software for connection to network interface 1348 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
selecting a first proximate relay station, employed by a secondary receiver to communicate with a secondary transmitter, based on an assessment of a first set of communication links extending from the first proximate relay station to the secondary receiver; and
selecting a second proximate relay station, employed by the secondary transmitter to communicate with the secondary receiver, based on an assessment of a second set of communication links extending from a secondary transmitter and the second proximate relay station.

2. The method of claim 1, the selecting of the first proximate relay station further comprising identifying the first proximate relay station based on the first set of communication links being non-primary user blocked links.

3. The method of claim 1, the selecting of the first proximate relay station further comprising maximizing a channel gain associated with the first set of communication links extending from the first proximate relay station to the secondary receiver.

4. The method of claim 1, the selecting of the first proximate relay station further comprising broadcasting an index of the first proximate relay station on a control channel.

5. The method of claim 4, the selecting of the second proximate relay station further comprising identifying the second proximate relay station based on the second set of communication links extending from the secondary transmitter to the second proximate relay station.

6. The method of claim 5, the selecting of the second proximate relay station further comprising maximizing a channel gain of the second set of communication links with respect to all other communication links extending from the secondary transceiver to the second proximate relay station, and second proximate relay station and the first proximate relay station differ.

7. A system, comprising:
a secondary receiver configured to select a first proximate relay station based on an evaluation of a first set of communication links that extend from the first proximate relay station to the secondary receiver; and
a secondary transmitter configured to select a second proximate relay station based on an evaluation of a second set of communication links that extend from the secondary transmitter and the second proximate relay station, wherein the first proximate relay station is employed by the secondary receiver to communicate with the secondary transmitter and the second proximate relay station is utilized by the secondary transmitter to communicate with the secondary receiver.

8. A computer-readable medium storing computer executable instructions for causing a computer to execute instructions, the computer executable instructions, comprising:
code for selecting a first proximate relay station, utilized by a secondary receiver to communicate with a secondary transmitter, based on an assessment of a first set of communication links extending from the first proximate relay station to the secondary receiver; and
code for selecting a second proximate relay station, utilized by secondary transmitter to communicate with the secondary receiver, based on an assessment of a second set of communication links that extend from a secondary transmitter and the second proximate relay station.

9. A method, comprising:
identifying a best relay station from a set of non-empty relay stations as a function of links between the set of non-empty relay stations and a secondary receiver, or links between a secondary transmitter and the set of non-empty relay stations; and
broadcasting an index of selected relay stations on a control channel when the best relay station is selected from the set of non-empty relay stations that are a function of links between the set of non-empty relay stations and the secondary receiver.

10. The method of claim 9, wherein the set of non-empty relay stations are associated with links that are non-primary user blocked.

11. The method of claim 9, further comprising picking the best relay station by ensuring that the best relay station selected by the secondary receiver differs from the best relay station selected by the secondary transmitter.

12. A system, comprising:
a component that identifies a best relay station from a set of non-empty relay stations as a function of links between the set of non-empty relay stations and a secondary receiver, or links between a secondary transmitter and the set of non-empty relay stations, wherein the component broadcasts an index of selected relay stations on a control channel in response to the best relay station being selected from the set of non-empty relay stations that are a function of links between the set of non-empty relay stations and the secondary receiver.

13. A computer-readable medium storing computer executable instructions for causing a computer to execute instructions, the computer executable instructions, comprising:
code for identifying a best relay station from a set of non-empty relay stations based on links between the set of non-empty relay stations and a secondary receiver, or links between a secondary transmitter and the set of non-empty relay stations; and
code for broadcasting an index of selected relay stations on a control channel when the best relay station is selected from the set of non-empty relay stations that are based on links between the set of non-empty relay stations and the secondary receiver.

14. A method, comprising:
receiving an acknowledgement packet from a secondary receiver; and
deleting a packet from a buffer of infinite length in a first-in-first out manner, wherein the buffer is associated with a relay station selected by the secondary receiver based on non-primary user blocked links between the relay station and the secondary receiver and the non-primary user blocked links exhibit a channel gain that exceeds the channel gain associated with other non-primary user blocked links between another relay station and the secondary receiver.

15. A system, comprising:
an acknowledgment assessor that ascertains whether an acknowledgement has been received from a secondary receiver that selected the system based on non-primary blocked links between the system and the secondary receiver and the non-primary blocked links having channel gains that exceed channels gains exhibited by other non-primary user blocked links between other relay stations and the secondary receiver; and
a packet deletion component that removes a packet off a buffer in a first-in-first-out manner in response to the acknowledgement assessor ascertaining that an acknowledgment has been received from the secondary receiver.

16. A computer-readable medium storing computer executable instructions for causing a computer to execute instructions, the computer executable instructions, comprising:
code for receiving an acknowledgement packet from a secondary receiver; and
code for deleting a packet from a buffer of infinite length in a first-in-first out manner, wherein the buffer is associated with a relay station selected by the secondary receiver as a function of non-primary user blocked links between the relay station and the secondary receiver and the non-primary user blocked links exhibiting a channel gain that exceeds the channel gain associated with other non-primary user blocked links between another relay station and the secondary receiver.

17. A method, comprising:
obtaining an acknowledgement packet sent from a selected relay station to a secondary transmitter, wherein the selected relay station was identified as being a preferable relay station based on non-primary user blocked communication links between the secondary transmitter and the selected relay station, the non-primary user blocked communication links have channel gains that exceed channels gains associated with other non-primary user blocked communication links from the secondary transmitter and other non-selected relays stations, and the selected relay station is not a selected relay station associated with a secondary receiver with which the secondary transmitter is in communication; and
removing a packet from a queue associated with the secondary transmitter in response to obtaining the acknowledgement packet.

18. A system, comprising:
an acknowledgment determinator that differentiates between an acknowledgement packet and a negative acknowledgement packet sent from a selected relay station to a secondary transmitter, wherein the selected relay station was identified as being a preferable relay station based on non-primary user blocked communication links between the secondary transmitter and the selected relay station, the non-primary user blocked communication links have channel gains that exceed channels gains associated with other non-primary user blocked communication links from the secondary transmitter and other non-selected relays stations, and the selected relay station is not a selected relay station associated with a secondary receiver with which the secondary transmitter is in communication; and
packet removal component that removes a packet from a queue associated with the secondary transmitter based on receipt of the acknowledgement packet.

19. A computer-readable medium storing computer executable instructions for causing a computer to execute instructions, the computer executable instructions, comprising:
code for obtaining an acknowledgement packet sent from a selected relay station to a secondary transmitter, wherein the selected relay station was identified as being a preferable relay station based on non-primary user blocked communication links between the secondary transmitter and the selected relay station, the non-primary user blocked communication links have channel gains that exceed channels gains associated with other non-primary user blocked communication links from the secondary transmitter and other non-selected relays stations, and the selected relay station is not a selected relay station associated with a secondary receiver with which the secondary transmitter is in communication; and
code for removing a packet from a queue associated with the secondary transmitter in response to obtaining the acknowledgement packet.
